(19) United States
(12) Patent Application Publication
(10) Pub. No.: US 2012/0157357 A1
(43) Pub. Date: Jun. 21, 2012

(54) DETERGENT PACKAGE FOR IMPROVED RECOVERY AND TRANSPORT OF CRUDE OIL

(75) Inventors: Pedro Cesar Ortega Osuna, Los Teques (VE); Miguel Angel Paraco Mendez, Los Teques (VE); Omar Jose Uzcategui Santiago, San Antonio de los Altos (VE); Rosa Elena La Cruz Herrera, San Antonio de los Altos (VE); Emir Eustoquio Escalona Arnal, Los Teques (VE); Jose Gregorio Figueredo Diaz, Los Teques (VE)

(73) Assignee: INTEVEP, S.A., Caracas (VE)

(21) Appl. No.: 12/973,406

(22) Filed: Dec. 20, 2010

(51) Int. Cl. C09K 8/584

(52) U.S. Cl. 507/240; 507/252

(57) ABSTRACT

A detergent package for changing wettability of a hydrocarbon bearing formulation and method regarding the same, comprising, at least one surfactant selected from the group consisting of sodium dodecyl benzene sulfonate, sodium dodecyl sulfate and mixtures thereof, and additional components selected from the group consisting of corrosion inhibitors, alkaline agents, oxidizers, bleaches, secondary surfactants, divalent sequestering cations, foaming agents, inert additives and combinations thereof.

### BACKGROUND OF THE INVENTION

The invention relates to production of hydrocarbons from subterranean hydrocarbon bearing formations and, more particularly, to a package and method for using the package which improves the recovery rate of such hydrocarbons.

Normal or primary production of a hydrocarbon bearing formation is conducted by utilizing pressure within the subterranean formation to drive fluids from the formation through a well which has pierced the formation and to the surface, where such hydrocarbons can be processed and used as desired.

Some formations either begin with insufficient pressure, or reach insufficient pressure through production to the point where hydrocarbons can no longer be produced in sufficient volumes from the well. Further, various conditions in the hydrocarbon bearing formation can interfere with production such as high viscosity of the hydrocarbon materials, poor permeability of the formation, poor water wettability and various different other chemical interactions between the hydrocarbons and the formation. Various techniques have been developed for enhancing recovery from such formations. All of these techniques are collectively referred to as Enhanced Oil Recovery (EOR), and they include displacement of hydrocarbons by sweeping with water, or by sweeping with surfactant solutions, caustic sweeping, sweeping with polymers, thermal methods of recovery and the like.

While all of these techniques can have positive effects on producing hydrocarbons from formations, the need remains for additional techniques that can be useful for producing hydrocarbons in a more efficient manner.

It is the primary object of the present invention to provide an additional procedure.

### SUMMARY OF THE INVENTION

In accordance with the present invention, a procedure is provided for improving recovery of hydrocarbons from hydrocarbon bearing formations wherein the procedure utilizes a detergent package, typically in an aqueous treatment solution, to alter the wettability from oil wet to water wet, and thereby release adhered hydrocarbons from the formation to allow their production. In addition, after initial treatment with the detergent in solution, production of the detergent solution and freed hydrocarbons enhance the oil mobility thus driving other hydrocarbons into the producing zone of the formation, where a film of the treatment solution remains to prevent new hydrocarbons from wetting the formation and to enhance their production.

According to the invention, a detergent package is provided for altering wettability, such as with water, of a hydrocarbon bearing formation, and this package preferably comprises an aqueous solution having at least one surfactant selected from the group consisting of sodium dodecyl benzene sulfonate, sodium dodecyl sulfate, sodium alkyl sulfate and mixtures thereof, and at least one component selected from the group consisting of corrosion inhibitors, alkaline agents, oxidizers, bleaches, secondary surfactants, divalent sequestering cations, foaming agents, inert additives and combinations thereof.

A treatment solution according to the invention typically includes the detergent package in an aqueous solution, preferably having at least one surfactant selected from the group consisting of sodium dodecyl benzene sulfonate, sodium dodecyl sulfate, sodium alkyl sulfate and mixtures thereof, and at least one component selected from the group consisting of corrosion inhibitors, alkaline agents, oxidizers, bleaches, secondary surfactants, divalent sequestering cations, foaming agents, inert additives and combinations thereof, wherein the detergent package is in the aqueous solution at a concentration of between about 1 and about 10% by weight.

The treatment solution can be used in a typical “huff and puff” type procedure, by pumping the solution into a hydrocarbon producing formation and holding that solution in the formation for a “soaking” period during which the solution changes wettability, such as from oil wet to water wet, of the formation, and releases hydrocarbons adhered to the formation. The detergent wets the formation. After a sufficient amount of time has elapsed, the treatment solution and freed hydrocarbon are produced back through the well, and additional hydrocarbon migrates into the formation vacated by the solutions and hydrocarbons, which were produced. The change can be visualized as a layer of surfactant molecules, such as sodium alkyl benzene sulfonate attached to the crude oil polar molecules, which in turn are attached to the rock. The produced mixture of treatment solution and hydrocarbon can then advantageously be transported though a pipeline to various other locations for refining and/or use as desired. The transportation is advantageous because the internal surface of the pipeline is water wet by the produced mixture. The water wet surface of the pipe aids in the ease of transportation.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

A detailed description of preferred embodiments of the present invention follows, with reference to the attached drawings, wherein:

FIGS. 1-3 schematically illustrate the method of the present invention;

FIG. 4 schematically illustrates the method for determining the amount of detergent used in the present invention; and,

FIG. 5 illustrates the release of hydrocarbons from the formation by the detergent of the present invention according to what is believed to be the way that the detergent package interacts with formation oil.

### DETAILED DESCRIPTION

The invention relates to a detergent package and its use in enhancing recovery of hydrocarbons from hydrocarbon bearing formations. The detergent package alters the wettability of the formation so as to release hydrocarbons adhered to the formation and allow these hydrocarbons to be produced. Further, the detergent package wets the formation and creates a film, such as a water-wet film, on the pores of the formation, which can speed the flow of additional hydrocarbons through this zone of the formation and to a well for production to the surface.

The detergent package of the present invention is preferably a combination of various components, which are selected in order to effectively change wettability in a reasonable period of time. The components used are reasonably friendly to the environment and will not cause formation issues associated with additional damage.

According to the invention the detergent package preferably comprises a mixture of the following components:

| | Weight Percentage |
|---|---|
| sodium dodecyl benzene sulfonate | 10-20 |
| sodium silicate | 1-7 |
| sodium carbonate | 15-25 |
| sodium percarbonate | 10-20 |
| sodium dodecyl sulfate | 1-8 |
| citric acid or sodium citrate | 1-8 |
| ethoxilated alcohol | 1-5 |
| inert additives | 5-10 |

Sodium dodecyl benzene sulfonate is the critical component in the detergent package. The remainder of the components of the detergent package are builders, meaning that each can enhance the function of the package in one or more ways. Thus, within the broad scope of the invention, any combination of the additional components can be included, and it is most preferred that all be included as listed above. The additional components increase the ability of the sodium dodecyl benzene sulfonate to release adhered hydrocarbons from the formation. For a non limiting example of the additional components: sodium silicate and/or quaternary aryl ammonium chloride may be used as a corrosion inhibitor; sodium carbonate and/or potassium carbonate may be used as an alkaline agent for pH adjustments; sodium percarbonate and/or sodium, perborate may be used as an oxidizer or bleach; sodium dodecyl sulfate and/or sodium alkyl sulfate may be used as a secondary surfactant in conjunction with the sodium dodecyl benzene sulfonate; citric acid, sodium citrate and/or sodium tripolyphosphate may be used as divalent sequestering cations; and, the ethoxilated alcohol and/or ammonium lauryl sulfate may be used as a foaming agent. As a result, the additional components may be selected from the group consisting of corrosion inhibitors, alkaline agents, oxidizers, bleaches, secondary surfactants, divalent sequestering cations, foaming agents and combinations thereof. The additional components may be composed of any chemicals or treatments that increase the ability of the sodium dodecyl benzene sulfonate to release adhered hydrocarbons from the formation. The detergent may also contain inert additives, such as colorants, fillers and the like.

Once the above ingredient components are selected, the detergent package is advantageously utilized by mixing in an aqueous solution to produce a treatment solution, and is then pumped into a hydrocarbon producing formation for treatment of that formation.

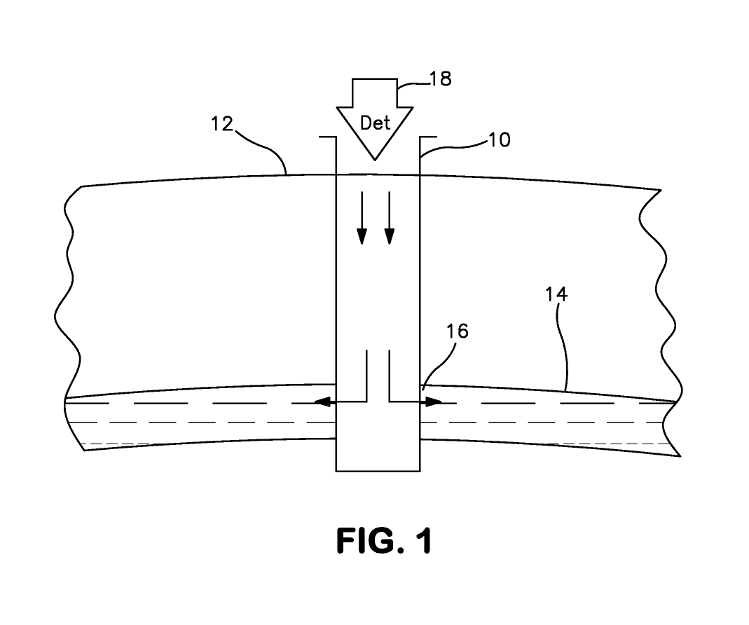

FIG. 1 schematically illustrates a well 10 penetrating from surface 12 to a hydrocarbon bearing formation 14. Well 10 has a fluid transfer region 16, such as perforations, through which fluids are typically produced from formation 14 through well 10 to the surface 12. As shown in FIG. 1, formation 14 can be treated in accordance with the invention by pumping a detergent solution 18 through well 10 and fluid transfer region 16 into the surrounding formation 14. FIG. 1 shows formation 14 with hydrocarbons schematically illustrated as wetting and adhered to the rock formation (represented by horizontal dashed lines). Solution 18 is pumped into formation 14 in amounts sufficient to penetrate the desired distance into the formation. The distance into the formation is calculated based upon the penetration radius of the solution. The penetration radius is determined by numerous factors, such as the amount of water in the formation and the consistency of the oil. A formation that is water cut or that contains heavy viscous oil will require a larger liquid penetration radius.

A treatment quantity can be determined based on the volume of a cylinder, defined by the desired penetration radius, and the height of the pay sand or producing formation, minus the volume of the slotted liner cylinder or well 10 (FIG. 1).

The displacement volume can be calculated in relation to the volume of the annulus and the volume of slotted liner, and the displacement fluid can suitably be gasoil, kerosene, or diluted detergent solution, in order to protect the steel structures of the well from corrosion.

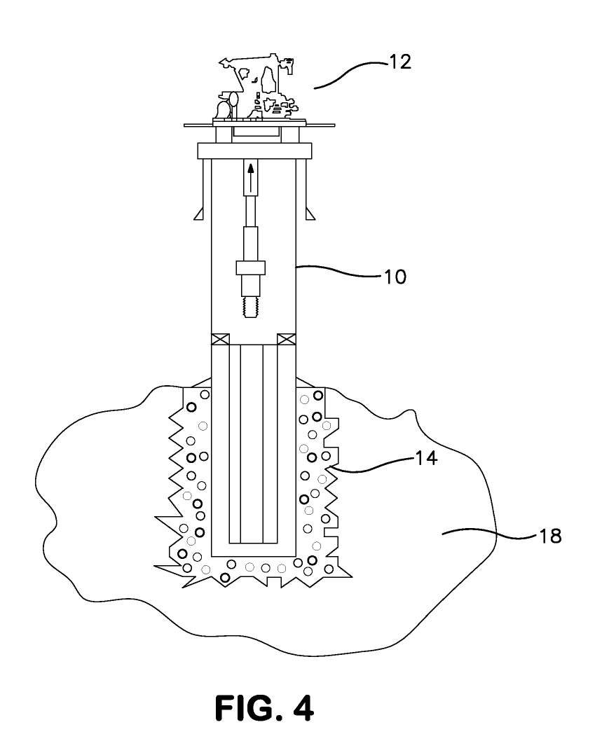

FIG. 4 further illustrates the quantity of treatment solution to use.

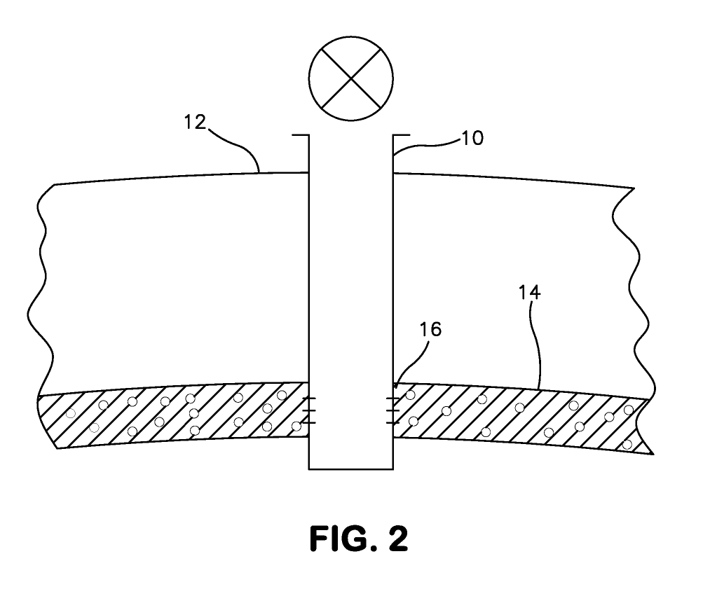

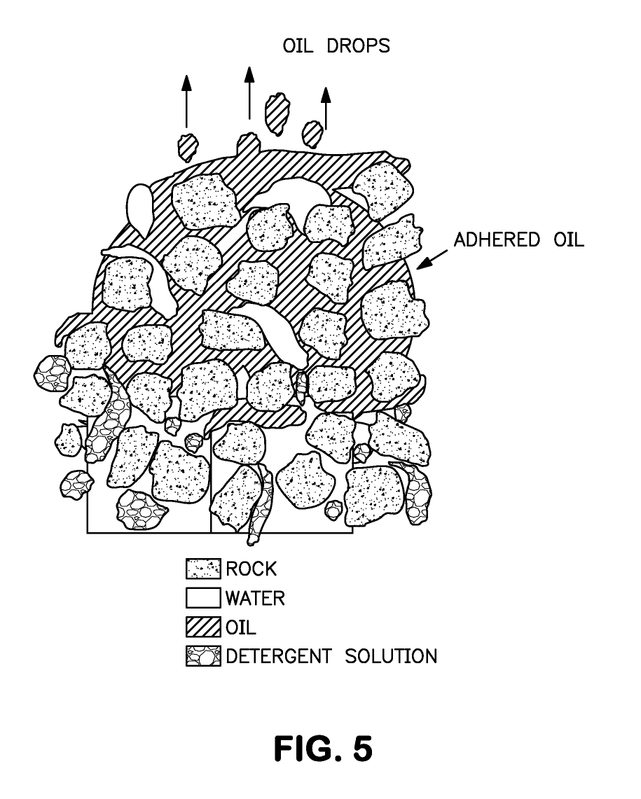

After pumping the solution into the formation as shown in FIG. 1, the solution is then held in the formation as shown in FIG. 2, wherein the circled X represents closed valves at the surface for holding the solution in the formation as desired. After a suitable amount of time has elapsed, during which the detergent solution has been soaking the formation, detergent gradually modifies the wettability of the formation and releases hydrocarbons adhered to the formation, leaving behind a film of the detergent solution on the formation. For example, the film can be left in the pore space of the formation, which is typically responsible for permeability to hydrocarbons in the formation, and the film can also be left on top of other hydrocarbons which may be attached to the reservoir. This change in condition is schematically represented by FIG. 5 and by the circles and lines drawn in formation 14 in FIG. 2. Typically, a formation can be treated with detergent solution according to the invention for a period of between about 24 hours and about 72 hours although this is a broad guideline. Certain formations can benefit from shorter and longer treatments as well.

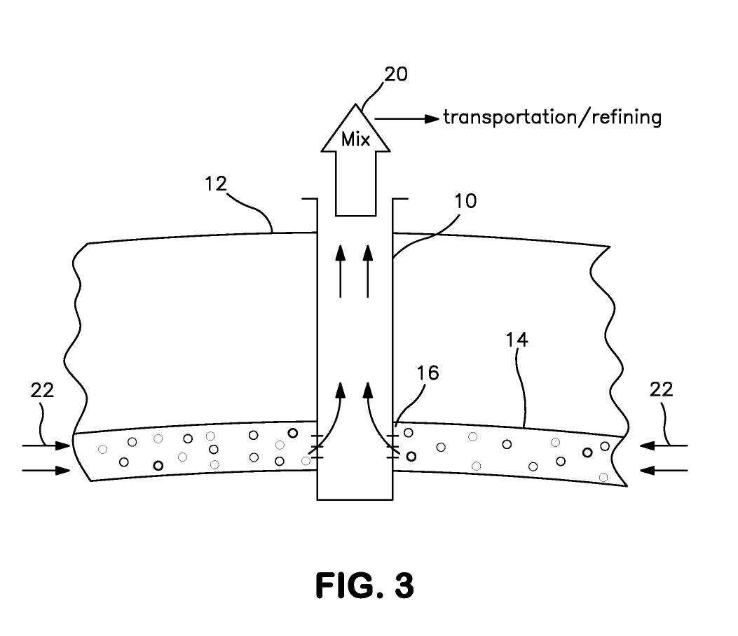

After sufficient soaking, fluids can again be produced from well 10 as shown in FIG. 3, and the fluids to be produced are a mixture 20 of detergent solution and freed hydrocarbon from formation 14. Due to the change in wettability in formation 14, these fluids flow much more freely from the formation into well 10 and to the surface 12. This can be done under the natural pressure of the formation, or utilizing other secondary oil recovery techniques if necessary, in order to produce the desired mixture.

Also as shown in FIG. 3, the change in wettability in the pay zone of formation 14 enhances the ability of surrounding hydrocarbons to migrate inwardly into the pay zone under the difference in pressure between the formation and the base of well 10. This provides additional hydrocarbons to be produced through well 10 as desired. This migration is illustrated schematically by arrows 22 to either side of the representation of formation 14.

Mixture 20 produced from well 10 can then be transported through pipelines and other transportation equipment to other remote locations and this is schematically illustrated in FIG. 3 showing mixture 20 being transported to other refining locations. When the mixture of oil and detergent solution are transported together, the detergent solution acts as a ‘pad’ by considerably diminishing the viscosity of the mixture and thus considerable diminishing the energy needed to pump the solution to the desired location. The padding effect of the detergent solution leads to both economic and technical savings. Once the mixture reaches the appropriate destination, the detergent solution is separated from the oil by any number of well-known separation methods, some of which can provide almost immediate separation.

As stated above, the detergent solution in accordance with the present invention advantageously frees hydrocarbons and makes the hydrocarbons producible through a formerly nonproducing or poorly producing well. While the exact mechanism of how the detergent acts upon the formation is not completely understood, it is believed that the mechanism for removing the oil is based upon the oily liquid surrounding the surfactant molecules of the detergent solution, resulting in the penetration of oily liquid, rolling of the particles of oily liquid, dispersions, solubilization, and/or emulsification of the freed particles of oily liquid. These steps occur due to changes in the wettability of the formation, which greatly enhanced the volume of hydrocarbons which can be produced.

It should be noted that the change in wettability of a formation can be measured or otherwise determined or estimated by comparing reliable displacement of permeability curves of the formation before and after a treatment. Of course, other methods for determining this change can be used.

As determined above, FIG. 5 shows the believed mechanism by which the detergent package functions. Detergent solution permeates the rock formation and by wetting the rock, releases oil which was adhered to the formation.

The detergent package of the present invention can be used in numerous applications including but not limited to oil and/or gas completions where the package can change wettability, clean the rock formation of fines and the like, and eliminate water or emulsion blocking. In addition, the invention can find useful application in the recovery and stimulation of production wells, especially those that have been subjected to steam injection. Such wells can become saturated by water and the detergent package can release this water. The detergent package of the present invention also finds useful application in gas well stimulation, even with gas wells having H₂S, even with added sodium carbonate.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope as defined by the claims.

What is claimed is:

1. A detergent package for changing wettability of a hydrocarbon bearing formation, comprising;
an aqueous solution having at least one surfactant selected from the group consisting of sodium dodecyl benzene sulfonate, sodium dodecyl sulfate, sodium alkyl sulfate and mixtures thereof, and at least one component selected from the group consisting of corrosion inhibitors, alkaline agents, oxidizers, bleaches, secondary surfactants, divalent sequestering cations, foaming agents, inert additives and combinations thereof.

2. The detergent package of claim 1, wherein the at least one additional component includes a corrosion inhibitor selected from the group consisting of sodium silicate, quaternary aryl ammonium chloride and combinations thereof.

3. The detergent package of claim 1, wherein the at least one additional component includes an alkaline agent selected from the group consisting of sodium carbonate, potassium carbonate and combinations thereof.

4. The detergent package of claim 1, wherein the at least one additional component includes an oxidizer selected from the group consisting of sodium percarbonate, sodium perborate and combinations thereof.

5. The detergent package of claim 1, wherein the at least one additional component includes a divalent sequestering cation selected from the group consisting of citric acid, sodium citrate, sodium tripolyphosphate and mixtures thereof.

6. The detergent package of claim 1, wherein the at least one additional component includes a foaming agent selected from the group consisting of ethoxilated alcohol, ammonium lauryl sulfate and combinations thereof.

7. A treatment solution for changing wettability of a hydrocarbon bearing formation, comprising:
a detergent package comprising an aqueous solution having at least one surfactant selected from the group consisting of sodium dodecyl benzene sulfonate, sodium dodecyl sulfate and mixtures thereof, and at least one additional component selected from the group consisting of corrosion inhibitors, alkaline agents, oxidizers, bleaches, secondary surfactants, divalent sequestering cations, foaming agents, inert additives and combinations thereof, wherein the detergent package is in the aqueous solution at a concentration of between 1 and 10% by weight.

8. The treatment solution of claim 7, wherein the corrosion inhibitor is selected from the group consisting of sodium silicate, quaternary aryl ammonium chloride and combinations thereof, wherein the alkaline agent is selected from the group consisting of sodium carbonate, potassium carbonate and combinations thereof, wherein the oxidizer is selected from the group consisting of sodium percarbonate, sodium perborate and combinations thereof, wherein the divalent sequestering cation is selected from the group consisting of citric acid, sodium citrate, sodium tripolyphosphate and mixtures thereof, and wherein the foaming agent is selected from the group consisting of ethoxilated alcohol, ammonium lauryl sulfate and combinations thereof.

9. A method for treating a hydrocarbon bearing formation, comprising the steps of:
injecting a treatment solution into a hydrocarbon bearing formation, wherein the treatment solution comprises an aqueous solution of a detergent package which comprises at least one surfactant selected from the group consisting of sodium dodecyl benzene sulfonate, sodium dodecyl sulfate and mixtures thereof, and additional components selected from the group consisting of corrosion inhibitors, alkaline agents, oxidizers, bleaches, secondary surfactants, divalent sequestering cations, foaming agents, inert additives and combinations thereof;
holding the treatment solution in the formation until the treatment solution wets the formation, whereby hydrocarbon adhered to the formation is released; and
producing the treatment solution and freed hydrocarbon from the formation.

10. The method of claim 9, further comprising the step of transporting a mixture of the treatment solution and freed hydrocarbon through a pipeline from a well producing from the formation, to a remote location.

11. The method of claim 9, wherein the formation is oil wet prior to the injecting step, and wherein the formation is detergent wet after the producing step.

12. The method of claim 9, wherein the at least one additional component includes a corrosion inhibitor selected from the group consisting of sodium silicate, quaternary aryl ammonium chloride and combinations thereof.

13. The method of claim 9, wherein the at least one additional component includes an alkaline agent selected from the group consisting of sodium carbonate, potassium carbonate and combinations thereof.

14. The method of claim 9, wherein the at least one additional component includes an oxidizer selected from the group consisting of sodium percarbonate, sodium perborate and combinations thereof.

15. The method of claim 9, wherein the at least one additional component includes a divalent sequestering cation selected from the group consisting of citric acid, sodium citrate, sodium tripolyphosphate and mixtures thereof.

16. The method of claim 9, wherein the at least one additional component includes a foaming agent selected from the group consisting of ethoxilated alcohol, ammonium lauryl sulfate and combinations thereof.

17. The method of claim 9, wherein the injecting step is conducted during completion of an oil or gas well to the hydrocarbon bearing formation.

18. The method of claim 9, wherein the hydrocarbon bearing formation is a formation that has been treated with steam injection.

19. The method of claim 9, wherein the hydrocarbon bearing formation contains gas including H₂S.
